(19) United States
(12) Patent Application Publication
(10) Pub. No.: US 2023/0402755 A1
(43) Pub. Date: Dec. 14, 2023

(54) ANTENNA DEVICE

(71) Applicant: DONGWOO FINE-CHEM CO., LTD., JEOLLABUK-DO (KR)

(72) Inventors: Ho Dong YOON, Gyeonggi-do (KR); Sung Jin HAN, Gyeonggi-do (KR); Young Sub SON, Seoul (KR)

(21) Appl. No.: 18/209,003

(22) Filed: Jun. 13, 2023

(30) Foreign Application Priority Data
Jun. 13, 2022 (KR) 10-2022-0071530

(51) Int. Cl. H01Q 9/04; H01Q 1/52

(52) U.S. Cl. CPC H01Q 9/0407; H01Q 1/521; H01Q 1/32

(57) ABSTRACT

An antenna device according to embodiments includes a dielectric layer having a central portion and a peripheral portion, a first antenna unit disposed on a top surface of the dielectric layer and including a first radiator providing a vertical radiation from the top surface of the dielectric layer, and a second antenna unit spaced apart from the first antenna unit on a plan view and comprising a second radiator providing an omni-directional radiation.

### CROSS-REFERENCE TO RELATED APPLICATION AND CLAIM OF PRIORITY

This application claims the benefit under 35 USC § 119 of Korean Patent Application No. 10-2022-0071530 filed on Jun. 13, 2022, in the Korean Intellectual Property Office (KIPO), the entire disclosures of which is incorporated herein by reference for all purposes.

### BACKGROUND

### 1. Field

The present invention relates to an antenna device. More particularly, the present invention relates to an antenna device including an antenna unit that includes a radiator.

### 2. Description of the Related Art

As information technologies have been developed, a wireless communication technology such as Wi-Fi, Bluetooth, etc., is combined or embedded in an image display device, an electronic device, an architecture, etc.

As mobile communication technologies have been rapidly developed, an antenna capable of operating a high frequency or ultra-high frequency communication is being applied to public transportations such as a bus and a subway, a building structure, and various mobile devices.

Accordingly, implementation of radiation properties in a plurality of frequency bands from a single antenna device may be needed. In this case, a high frequency antenna and a low frequency antenna may be included in a single device.

However, if antennas of different frequency bands are disposed to be adjacent to each other, radiation and impedance properties of the different antennas may collide with each other, and signaling in multiple direction may not be implemented.

For example, Korean Published Patent Application No. 2019-0009232 discloses an antenna module integrated into a display panel. However, a broadband antenna with improved radiation reliability is not disclosed.

### SUMMARY

According to an aspect of the present invention, there is provided an antenna device having improved radiation property and radiation reliability.
(1) An antenna device, including: a dielectric layer having a central portion and a peripheral portion; a first antenna unit disposed on a top surface of the dielectric layer, the first antenna unit including a first radiator providing a vertical radiation from the top surface of the dielectric layer; and a second antenna unit spaced apart from the first antenna unit on a plan view, the second antenna unit including a second radiator providing an omni-directional radiation.
(2) The antenna device according to the above (1), wherein the first antenna unit further includes a first transmission line electrically connected to the first radiator.
(3) The antenna device according to the above (1), wherein the second radiator includes a plurality of radiation portions, widths of which sequentially decrease.
(4) The antenna device according to the above (3), wherein the plurality of radiation portions include a first radiation portion, a second radiation portion and a third radiation portion, widths of which sequentially decrease.
(5) The antenna device according to the above (4), wherein the first radiation portion, the second radiation portion and the third radiation portion are arranged in a stepped shape.
(6) The antenna device according to the above (1), wherein the second antenna unit further includes: a second transmission line electrically connected to the second radiator; and an auxiliary radiator disposed around the second transmission line and physically spaced apart from the second radiator and the second transmission line.
(7) The antenna device according to the above (6), wherein the auxiliary radiator serves as a fourth radiation portion.
(8) The antenna device according to the above (1), wherein the first radiator and the second radiator have a mesh structure.
(9) The antenna device according to the above (8), further including a first dummy mesh pattern disposed around the first antenna unit and the second antenna unit to be spaced apart from the first antenna unit and the second antenna unit.
(10) The antenna device according to the above (1), wherein an area of the first radiator is smaller than an area of the second radiator.
(11) The antenna device according to the above (1), wherein the first antenna unit includes a plurality of first antenna units, and the second antenna unit includes a plurality of second antenna units.
(12) The antenna device according to the above (11), wherein the plurality of first antenna units are disposed on the central portion of the dielectric layer, and the plurality of second antenna units are disposed on the peripheral portion of the dielectric layer.
(13) The antenna device according to the above (11), wherein a distance between centers of the first radiators included in neighboring first antenna units among the plurality of first antenna units is ¼ of a radiation wavelength of the first radiator, and a distance between centers of the second radiators included in neighboring second antenna units among the plurality of second antenna units is ¼ of a radiation wavelength of the second radiator.
(14) The antenna device according to the above (1), further including a ground layer disposed on a bottom surface of the dielectric layer, the ground layer including a ground pattern.
(15) The antenna device according to the above (14), wherein at least a portion of the ground pattern overlaps the first antenna unit in the plan view.
(16) The antenna device according to the above (14), wherein the ground pattern is spaced apart from the second antenna unit in the plan view.
(17) The antenna device according to the above (14), wherein the ground pattern has a mesh structure.
(18) The antenna device according to the above (17), wherein the ground layer further includes a second dummy mesh pattern disposed around the ground pattern.
(19) The antenna device according to the above (18), wherein at least a portion of the second dummy mesh pattern overlaps the second antenna unit in the plan view.
(20) The antenna device according to the above (18), wherein the second dummy mesh pattern includes conductive lines crossing each other, and the second dummy mesh pattern has segmented regions at which the conductive lines are cut.

According to example embodiments, a first antenna unit included in an antenna device may provide a vertical radiation, and a second antenna unit may provide an omni-directional radiation. In this case, a high-frequency signal may be strongly transmitted and received at an inside of a target object through a directed radiation of the first antenna unit. Further, connection of the antenna device to a communication network at an outside the target object may be stably performed through the omni-directional radiation by the second antenna unit.

In some embodiments, at least a portion of a ground pattern included in a ground layer may overlap the first antenna unit in a plan view. Accordingly, the ground pattern may be provided as the ground of the first antenna unit to implement the vertical radiation.

In some embodiments, the second antenna unit may include a plurality of radiating portions, widths of which sequentially decrease. Accordingly, a multi-band antenna in which a multi-band signal transmission/reception is performed may be implemented in a single radiator.

### BRIEF DESCRIPTION OF THE DRAWINGS

FIG. 1 is a schematic cross-sectional view illustrating an antenna device in accordance with exemplary embodiments.

FIG. 2 is a schematic plan view illustrating an antenna device in accordance with exemplary embodiments.

FIG. 3 is a schematic plan view illustrating an antenna device in accordance with exemplary embodiments.

FIG. 4 is a schematic plan view illustrating an antenna device in accordance with exemplary embodiments.

FIG. 5 is a schematic plan view illustrating an antenna device in accordance with exemplary embodiments.

FIG. 6 is a schematic plan view illustrating an antenna device in accordance with exemplary embodiments.

FIG. 7 is a schematic view illustrating an exemplary application of an antenna device in accordance with exemplary embodiments.

### DETAILED DESCRIPTION OF THE EMBODIMENTS

According to exemplary embodiments of the present invention, an antenna device providing a radiation of a plurality of resonance frequency bands is provided.

Hereinafter, the present invention will be described in detail with reference to the accompanying drawings. However, those skilled in the art will appreciate that such embodiments described with reference to the accompanying drawings are provided to further understand the spirit of the present invention and do not limit subject matters to be protected as disclosed in the detailed description and appended claims.

The terms “upper,” “lower,” “top,” “bottom,” herein are used to relatively distinguish positions of components, and are not intended to designate absolute positions.

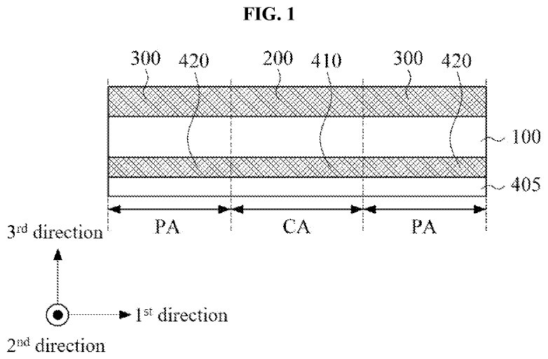

FIG. 1 is a schematic cross-sectional view illustrating an antenna device in accordance with exemplary embodiments.

Referring to FIG. 1, the antenna device may include a dielectric layer 100, a first antenna unit 200 and a second antenna unit 300 disposed on a top surface of the dielectric layer 100, and a ground layer 400 disposed on a bottom surface of the dielectric layer 100.

In FIG. 1, two directions that are parallel to the top surface of the dielectric layer 100 and cross each other are defined as a first direction and a second direction. For example, the first direction and the second direction may perpendicularly cross each other. A direction vertical to the top surface of the dielectric layer 100 is defined as a third direction.

For example, the first direction may correspond to a width direction of the antenna device, the second direction may correspond to a length direction of the antenna device, and the third direction may correspond to a thickness direction of the antenna device. The definitions of the directions may be equally applied to the accompanying drawings.

In example embodiments, the dielectric layer 100 may include a central portion CA and a peripheral portion PA. For example, a pair of the peripheral portions PA may be disposed on the same plane with the central portion CA interposed therebetween.

The dielectric layer 100 may include, e.g., a transparent resin material. For example, the dielectric layer 100 may include a polyester-based resin such as polyethylene terephthalate, polyethylene isophthalate, polyethylene naphthalate and polybutylene terephthalate; a cellulose-based resin such as diacetyl cellulose and triacetyl cellulose; a polycarbonate-based resin; an acrylic resin such as polymethyl (meth)acrylate and polyethyl (meth)acrylate; a styrene-based resin such as polystyrene and an acrylonitrile-styrene copolymer; a polyolefin-based resin such as polyethylene, polypropylene, a cycloolefin or polyolefin having a norbornene structure and an ethylene-propylene copolymer; a vinyl chloride-based resin; an amide-based resin such as nylon and an aromatic polyamide; an imide-based resin; a polyethersulfone-based resin; a sulfone-based resin; a polyether ether ketone-based resin; a polyphenylene sulfide resin; a vinyl alcohol-based resin; a vinylidene chloride-based resin; a vinyl butyral-based resin; an allylate-based resin; a polyoxymethylene-based resin; an epoxy-based resin; a urethane or acrylic urethane-based resin; a silicone-based resin, etc. These may be used alone or in a combination thereof.

An adhesive film such as an optically clear adhesive (OCA), an optically clear resin (OCR), etc., may be included in the dielectric layer 100.

In an embodiment, the dielectric layer 100 may include an inorganic insulating material such as glass, silicon oxide, silicon nitride, silicon oxynitride, etc.

In an embodiment, the dielectric layer 100 may be provided as a substantially single layer.

In an embodiment, the dielectric layer 100 may have a multi-layered structure of at least two layers. For example, the dielectric layer 100 may include a substrate layer and an antenna dielectric layer, and may include an adhesive layer between the substrate layer and the antenna dielectric layer.

For example, the dielectric layer 100 may include a lower dielectric layer and an upper dielectric layer. In this case, the first antenna unit 200 and the second antenna unit 300 may be disposed between the lower dielectric layer and the upper dielectric layer. For example, the first antenna unit 200 and the second antenna unit 300 may be sandwiched or embedded between the lower dielectric layer and the upper dielectric layer. Accordingly, dielectric and radiation environments around the first antenna unit 200 and the second antenna unit 300 may become uniform.

In an embodiment, the upper dielectric layer may serve as a coating layer, an insulating layer and/or a protective film of the antenna units 200 and 300 or the antenna device.

Impedance or inductance for the antenna units 200 and 300 may be generated by the dielectric layer 100, so that a frequency band at which the antenna device may be driven or operated may be adjusted. In some embodiments, a dielectric constant of the dielectric layer 100 may be adjusted in a range from about 1.5 to about 12. When the dielectric constant exceeds about 12, a driving frequency may be excessively decreased, so that driving in a desired high frequency band may not be implemented.

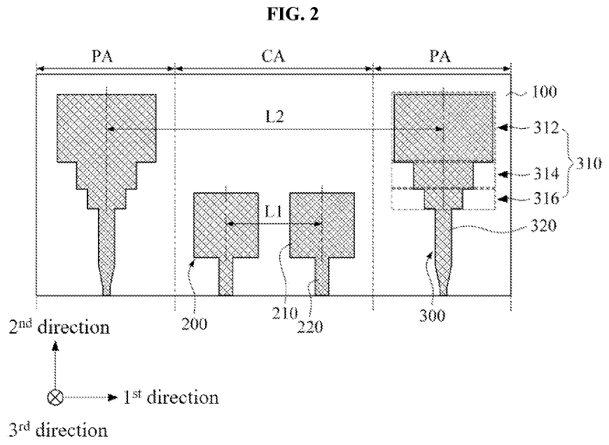

FIG. 2 is a schematic plan view illustrating an antenna device in accordance with exemplary embodiments.

Referring to FIG. 2, the first antenna unit 200 may include a first radiator 210 providing a vertical radiation from the top surface of the dielectric layer 100, and a first transmission line 220 electrically connected to the first radiator 210 may be included.

For example, the first antenna unit 200 or the first radiator 210 may serve as a patch antenna.

In some embodiments, the first radiator 210 may serve as a high frequency radiator of the antenna device.

For example, a resonance frequency of the first radiator 210 may be in a range from about 1.0 GHz to 6.0 GHz or from about 20 GHz to 45 GHz.

In an embodiment, a radiation band corresponding to a Wi-Fi band may be obtained from the first radiator 210. For example, the resonance frequency of the first radiator 210 may be in a range from about 2.2 GHz to 2.7 GHz or from about 4 GHz to 6 GHz.

In an embodiment, the first radiator 210 may be designed to have a resonance frequency corresponding to a high frequency or ultra-high frequency band of 3G, 4G, 5G or more.

The first transmission line 220 may transmit, e.g., a driving signal or a power from a driving integrated circuit (IC) chip to the first radiator 210.

For example, one end of the first transmission line 220 may be physically and electrically connected to the first radiator 210 to transmit the signal and power to the first radiator 210. The other end of the first transmission line 220 may be electrically connected to the driving IC chip through an antenna cable. Accordingly, signal transmission and reception and a feeding from the driving IC chip to the first radiator 210 may be performed.

In example embodiments, the second antenna unit 300 may be spaced apart from the first antenna unit 200 in a plan view.

The second antenna unit 300 may include a second radiator 310 providing an omni-directional radiation, and a second transmission line 320 electrically connected to the second radiator 310.

For example, a dipole antenna, a monopole antenna, a planar inverted-F antenna (PIFA), etc., may be used as the second antenna unit 300.

For example, the second radiator 310 may serve as a multi-band radiator of the antenna device.

In some embodiments, the second radiator 310 may include a plurality of radiation portions, widths of which may sequentially decrease. Accordingly, a multi-band antenna in which a multi-band signal transmission/reception may be performed may be implemented in a single radiator.

The term “width” used herein refers to a length in the first direction.

For example, a resonance frequency of the second radiator 310 may be in a range from about 0.7 GHz to about 6.0 GHz.

In an embodiment, a radiation band corresponding to an LTE band may be obtained from the second radiator 310. For example, a resonance frequency may be in a range from 0.8 GHz to 2.6 GHz.

In some embodiments, the plurality of radiation portions of the second radiator 310 may include a first radiation portion 312, a second radiation portion 314 and a third radiation portion 316, widths of which may be sequentially reduced. The third radiation portion 316, the second radiation portion 314 and the first radiation portion 312 may be sequentially disposed from a second transmission line 320 in a plan view.

The first radiation portion 312 may correspond to an uppermost portion or an outermost portion in the length direction of the second antenna unit 300 from the second transmission line 320 in the plan view.

The first radiation portion 312 may serve as a low frequency radiator of the second radiator 310 or the second antenna unit 300. For example, a radiation of the lowest frequency band obtained by the second antenna unit 300 may be implemented from the first radiation portion 312. For example, a resonance frequency of the first radiation portion 312 may be in a range from about 0.7 GHz to about 1.4 GHz.

In an embodiment, a radiation band corresponding to an LTE1 band may be obtained from the first radiation portion 312. In an embodiment, a resonance frequency of the first radiation portion 312 may be in a range from 0.5 GHz to 1 GHz, or from 0.6 GHz to 1 GHz.

The second radiation unit 314 may serve as a first mid-band radiator of the second radiator 310 or the second antenna unit 300. For example, an average resonance frequency of the second radiation portion 314 may be greater than an average resonance frequency of the first radiation portion 312. For example, the resonance frequency of the second radiation portion 314 may be in a range from about 1.5 GHz to 2.5 GHz.

In an embodiment, a radiation band corresponding to an LTE2 band may be obtained from the second radiation portion 314. For example, the resonance frequency of the second radiation portion 314 may be in a range from 1.7 GHz to 2.0 GHz.

For example, the resonance frequency range of the second radiation portion 314 may partially overlap a resonance frequency range of the third radiation portion 316.

In some embodiments, the second radiation portion 314 may have a smaller width than that of the first radiation part 312.

In some embodiments, a first recess may be formed at a boundary between the first radiation portion 312 and the second radiation portion 314. The recessed boundary portion may be formed, so that independent radiation properties of the first radiation portion 312 and the second radiation portion 314 may be enhanced. For example, the above-described low-frequency band radiation from the first radiation portion 312 may be prevented from disturbing the first mid-band radiation from the second radiation portion 314.

The third radiation portion 316 may serve as a second mid-band radiator having a higher resonance frequency range than that of the second radiator 310 or the second radiation portion 314 of the second antenna unit 300. For example, a resonance frequency of the third radiation portion 316 may be in a range from about 2.0 GHz to 3.0 GHz.

In an embodiment, a radiation band corresponding to an LTE2 band/2.4 GHz Wi-Fi band may be obtained from the third radiation portion 316. For example, the resonance frequency of the third radiation portion 316 may be in a range from about 2.2 GHz to 2.7 GHz.

For example, the resonance frequency range of the third radiation portion 316 may partially overlap the resonance frequency range of the second radiation unit 314.

In some embodiments, the third radiation portion 316 may have a smaller width than each width of the first radiation portion 312 and the second radiation portion 314.

In some embodiments, a second recess may be formed at a boundary between the second radiation portion 314 and the third radiation portion 316. Independence and reliability of radiation through the third radiation portion 316 may be improved by the second recess.

In some embodiments, the second transmission line 320 may be directly connected to the third radiation portion 316.

The second transmission line 320 may transmit, e.g., a driving signal or power from the driving integrated circuit (IC) chip to the second radiator 310.

For example, one end portion of the second transmission line 320 may be physically and electrically connected to the third radiation portion 316 to transmit the signal and power to the second radiator 310. The other end portion of the second transmission line 320 may be electrically connected to the driving IC chip through an antenna cable. Accordingly, signal transmission/reception and feeding from the driving IC chip to the second radiator 310 may be performed.

In some embodiments, the second transmission line 320 may include an inclined portion, a width of which increases in a direction from the other end portion thereof to the second radiator 310. Accordingly, noises around the other end portion connected to an external circuit may be suppressed, and an antenna gain may be improved.

In some embodiments, the first radiation portion 312, the second radiation portion 314 and the third radiation portion 316 of the second radiator 310 may be arranged in a stepped shape. Accordingly, independence of a driving frequency band of each driving radiating portion may be improved.

In some embodiments, each lateral side of the radiating portions 312, 314 and 316 of the second radiator 310 may have a straight line shape. For example, each of the first radiation portion 312, the second radiation portion 314 and the third radiation portion 316 may have a rectangular shape. Accordingly, signal transmission between the radiating portions may be implemented while suppressing an impedance fluctuation. Additionally, the frequency band may be easily adjusted in a desired band.

In an embodiment, all sides of the second radiator 310 may have a straight line shape.

In some embodiments, a length of the first radiation portion 312, a length of the second radiation portion 314 and a length of the third radiation portion 316 may be different from each other. Accordingly, an interval between driving frequency bands of the radiating portions may be easily adjusted/modified.

In some embodiments, the length of the first radiation portion 312, the length of the second radiation portion 314 and the length of the third radiation portion 316 may be sequentially decreased. In this case, the interval between the driving frequency bands of the radiating portions may be widened.

For example, a band between the driving frequency range of the first radiation portion 312 and the driving frequency range of the second radiation portion 314 may be widened, and a band between the driving frequency range of the second radiation portion 314 and the driving frequency range of the third radiation portion 316 may be widened. Accordingly, interference and disturbance between the driving frequency ranges may be prevented, and resolution in each driving frequency range may be improved.

The term “length” used herein refers to a length in the second direction.

In some embodiments, lengths of the first radiation portion 312, the second radiation portion 314 and/or the third radiation portion 316 may be appropriately changed/adjusted according to the target driving frequency. Even in this case, the average resonance frequency of the first radiation portion 312 may be smaller than the average resonance frequency of the second radiation portion 314, and the average resonance frequency of the second radiation portion 314 may be smaller than the average resonance frequency of the third radiation portion 316.

In some embodiments, an area of the first radiator 210 may be smaller than that of the second radiator 310. Accordingly, the driving frequency of the first radiator 210 may become higher than the driving frequency of the second radiator 310, and a multi-band signal transmission and reception may be implemented in one antenna device.

In some embodiments, the first antenna unit 200 may include a plurality of first antenna units, and the second antenna unit 300 may include a plurality of second antenna units.

The plurality of first antenna units 200 may be disposed on the central portion CA of the dielectric layer 100, and the plurality of second antenna units 300 may be disposed on the peripheral portion PA of the dielectric layer 100.

For example, the first antenna units 200 are disposed to be adjacent to each other on the central portion CA, and the second antenna units 300 are spaced apart with the first antenna units 200 interposed therebetween on the peripheral portion PA.

In some embodiments, a distance L1 between centers of the first radiators 210 of the first antenna units adjacent to each other among the plurality of first antenna units 200 may be about ¼ (λ/4) of a radiation wavelength (λ) of the first radiator 210.

A distance L2 between centers of the second radiators 310 of the second antenna units adjacent to each other among the plurality of second antenna units 300 may be about ¼ (λ/4) of a radiation wavelength (λ) of the second radiator 310.

In this case, signal interference between the first radiators 210 and signal interference between the second radiators 310 may be effectively suppressed.

As described above, the first radiator 210 may be radiated in a higher frequency band than that of the second radiator 310. In this case, the radiation wavelength of the first radiator 210 may be shorter than that of the second radiator 310. Accordingly, the distance L1 between the centers of the neighboring first radiators 210 may be shorter than the distance L2 between the centers of the neighboring second radiators 310.

As described above, the first antenna units 200 may be disposed together on the central portion CA, and the second antenna units 300 may be spaced apart from each other on the peripheral portion PA with the central portion CA interposed therebetween. Accordingly, spatial efficiency of the antenna device may be improved while maintaining the above-described distances L1 and L2 between the centers of the radiators 210 and 310.

In an embodiment, two first radiators 210 may be adjacent to each other on the central portion CA, and two second radiators 310 may be spaced apart from each other in the first direction with the first radiators 210 interposed therebetween.

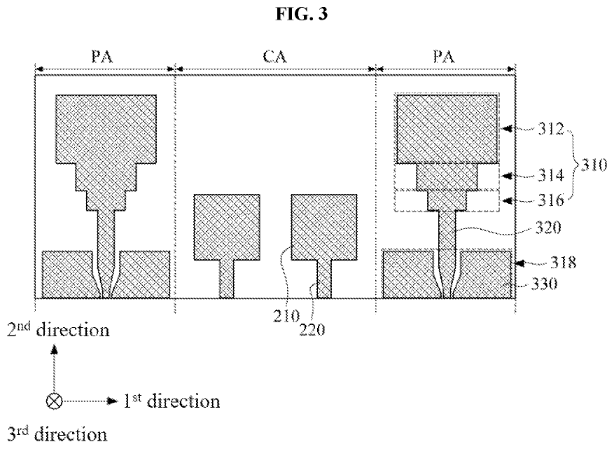

FIG. 3 is a schematic plan view illustrating an antenna device in accordance with exemplary embodiments.

Referring to FIG. 3, the second antenna unit 300 may further include an auxiliary radiator 330 which is disposed around the second transmission line 320 to be physically separated from and the second radiator 310 and the second transmission line 320. For example, a pair of the auxiliary radiators 330 may face each other with the second transmission line 320 interposed therebetween.

For example, the auxiliary radiator 330 may serve as a ground of the second antenna unit 300 to remove a noise from the second transmission line 320 and to improve signal efficiency.

In some embodiments, the auxiliary radiator 330 may serve as a fourth radiation portion 318 by an electrical coupling with the second radiator 310 and/or the second transmission line 320 of the second antenna unit 300.

The fourth radiation portion 318 may serve as a high frequency radiation region of the second antenna unit 300. For example, radiation of the highest frequency band obtained by the second antenna unit 300 may be implemented from the fourth radiation portion 318. For example, a resonance frequency of the fourth radiation portion 318 may be in the range from about 3.0 GHz to 6.0 GHz.

In an embodiment, a radiation band corresponding to Sub-6 5G may be obtained from the fourth radiation portion 318. In an embodiment, the resonance frequency of the fourth radiator 318 may be in a range from about 3 GHz to 4 GHz, or from about 3.1 GHz to 3.8 GHz.

An average resonance frequency of the fourth radiation portion 318 may be greater than the average resonance frequency of the third radiation portion 316.

The above-described driving frequency bands of the first radiation portion 312, the second radiation portion 314, the third radiation portion 316 and the fourth radiation portion 318 may be exemplary, and may be properly adjusted or modified.

As illustrated in FIG. 3, the auxiliary radiator 330 may include a region, a width of which decreases along the second direction. In this case, a distance between the auxiliary radiator 330 and the second transmission line 320 may decrease toward the other end portion of the second transmission line 320. Accordingly, loss of the signal transmitted to the second radiator 310 at a portion where the second transmission line 320 is connected to the external circuit may be reduced.

The first antenna unit 200 and the second antenna unit 300 may include silver (Ag), gold (Au), copper (Cu), aluminum (Al), platinum (Pt), palladium (Pd), chromium (Cr), titanium (Ti), tungsten (W), and niobium. (Nb), tantalum (Ta), vanadium (V), iron (Fe), manganese (Mn), cobalt (Co), nickel (Ni), zinc (Zn), tin (Sn), molybdenum (Mo), calcium (Ca) or an alloy containing at least one of the metals. These may be used alone or in combination of two or more therefrom.

In an embodiment, the first antenna unit 200 and the second antenna unit 300 may include silver (Ag) or a silver alloy (e.g., silver-palladium-copper (APC)), or copper (Cu) or a copper alloy (e.g., a copper-calcium (CuCa)) to implement a low resistance and a fine line width pattern.

In some embodiments, the first antenna unit 200 and the second antenna unit 300 may include a transparent conductive oxide such indium tin oxide (ITO), indium zinc oxide (IZO), zinc oxide (ZnOx), indium zinc tin oxide (IZTO), etc.

In some embodiments, the first antenna unit 200 and the second antenna unit 300 may include a stacked structure of a transparent conductive oxide layer and a metal layer. For example, the first antenna unit 200 and the second antenna unit 300 may include a double-layered structure of a transparent conductive oxide layer-metal layer, or a triple-layered structure of a transparent conductive oxide layer-metal layer-transparent conductive oxide layer. In this case, flexible property may be improved by the metal layer, and a signal transmission speed may also be improved by a low resistance of the metal layer. Corrosive resistance and transparency may be improved by the transparent conductive oxide layer.

The first antenna unit 200 and the second antenna unit 300 may include a blackened portion, so that a reflectance at a surface of the first antenna unit 200 and the second antenna unit 300 may be decreased to suppress a visual recognition of the antenna unit due to a light reflectance.

In an embodiment, a surface of the metal layer included in the first antenna unit 200 and the second antenna unit 300 may be converted into a metal oxide or a metal sulfide to form a blackened layer. In an embodiment, a blackened layer such as a black material coating layer or a plating layer may be formed on the first antenna unit 200 and the second antenna unit 300 or the metal layer. The black material or plating layer may include silicon, carbon, copper, molybdenum, tin, chromium, molybdenum, nickel, cobalt, or an oxide, sulfide or alloy containing at least one therefrom.

A composition and a thickness of the blackened layer may be adjusted in consideration of a reflectance reduction effect and an antenna radiation property.

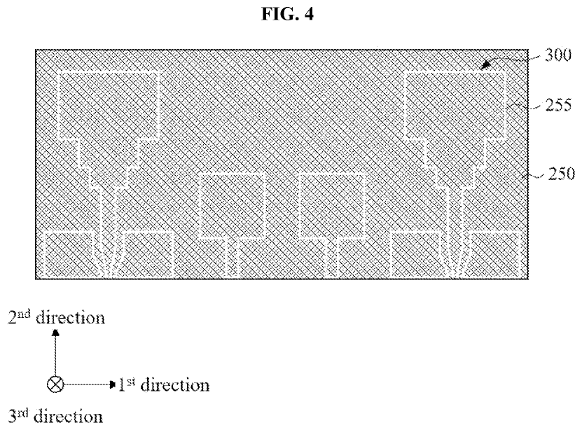

FIG. 4 is a schematic plan view illustrating an antenna device in accordance with exemplary embodiments.

Referring to FIG. 4, the antenna device may further include a first dummy mesh pattern 250 disposed around the first antenna unit 200 and the second antenna unit 300. For example, the first dummy mesh pattern 250 may be electrically and physically separated from the antenna units 200 and 300 by a separation region 255.

For example, a conductive layer containing the metal or alloy described above may be formed on the dielectric layer 100. A mesh structure may be formed while etching the conductive layer along circumference profiles of the antenna units 200 and 300 as described above. Accordingly, the antenna units 200 and 300 and the first dummy mesh pattern 250 spaced apart from each other by the separation region 255 may be formed.

In some embodiments, the first antenna unit 200 and the second antenna unit 300 may also share a mesh structure. Accordingly, transmittance of the first antenna unit 200 and the second antenna unit 300 may be improved, and optical properties around the first antenna unit 200 and the second antenna unit 300 may become uniform by the distribution of the first dummy mesh pattern 250. Thus, the first antenna unit 200 and the second antenna unit 300 may be prevented from being visually recognized.

In an embodiment, the first antenna unit 200 and the second antenna unit 300 may entirely include the mesh structure. In an embodiment, at least a portion of the first transmission line 220 and the second transmission line 320 and at least a portion of the auxiliary radiator 330 may include a solid structure for enhancing a feeding efficiency.

The antenna device may be applied to various objects as described later. If the auxiliary radiator 330 is disposed in a non-visible area by a user in the object, the auxiliary radiator 330 may include the solid structure.

For example, if the first antenna unit 200 and the second antenna unit 300 are disposed in the non-visible area by the user in the object to which the antenna device is applied, the first antenna unit 200 and the second antenna unit 300 may include the solid structure.

The first dummy mesh pattern 250 may include intersecting conductive lines forming a mesh structure. In some embodiments, the first dummy mesh pattern 250 may include segment regions where the conductive lines are cut. Accordingly, the radiation properties of the first antenna unit 200 and the second antenna unit 300 may be prevented from being disturbed by the first dummy mesh pattern 250.

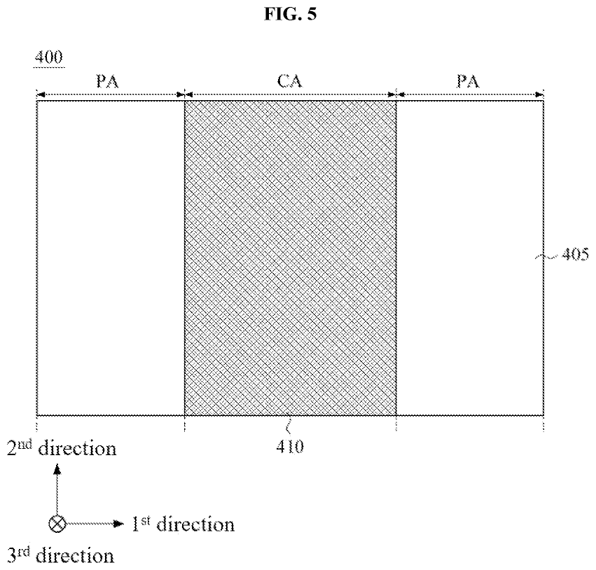

FIG. 5 is a schematic plan view illustrating an antenna device in accordance with exemplary embodiments. Specifically, FIG. 5 is a schematic plan view illustrating a ground layer 400 of an antenna device according to exemplary embodiments.

Referring to FIG. 5, the ground layer 400 may be disposed on the bottom surface of the dielectric layer 100.

In some embodiments, the ground layer 400 may include a ground substrate 405 and a ground pattern 410 formed on the ground substrate 405. The ground substrate 405 may include substantially the same material as the above-described material for the dielectric layer 100.

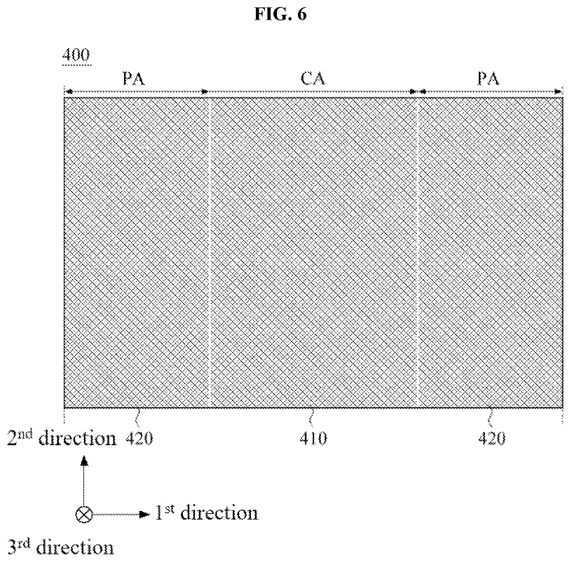

In some embodiments, the ground layer 400 may be formed directly on the bottom surface of the dielectric layer 100. For example, the ground pattern 410 and a second dummy mesh pattern 420 (see FIG. 6) may be directly patterned on the bottom surface of the dielectric layer 100. In this case, a separate ground substrate may be omitted to reduce a thickness of the antenna device.

For example, at least a portion of the ground pattern 410 may overlap the first antenna unit 200 in a plan view. For example, at least a portion of the ground pattern 410 may overlap the first antenna unit 200 in the third direction. Accordingly, the ground pattern 410 may serve as a ground for the first antenna unit 200, so that the vertical radiation of the first radiator 210 may be implemented.

For example, the ground pattern 410 may be disposed on the bottom of the central portion CA of the dielectric layer 100. In an embodiment, the ground pattern 410 may entirely cover the first antenna unit 200 in the plan view.

For example, if a conductive ground is disposed under the second antenna unit 300, broadband radiation and omni-directional (non-directional) radiation may not be implemented.

In some embodiments, the ground pattern 410 may be spaced apart from the second antenna unit 300 in the plan view. For example, the ground pattern 410 may not overlap the second antenna unit 300 in the third direction. Accordingly, multi-band radiation/broadband radiation and omni-directional radiation of the second antenna unit 300 may be implemented.

FIG. 6 is a schematic plan view illustrating an antenna device in accordance with exemplary embodiments.

Referring to FIG. 6, the ground layer 400 may include the second dummy mesh pattern 420 disposed around the ground pattern 410 on the bottom surface of the peripheral portion PA of the dielectric layer 100.

In some embodiments, a conductive layer including the above-described metal or alloy may be formed on a top surface of the ground substrate 405. A mesh structure may be formed while etching the conductive layer along a profile including both lateral sides of the ground pattern 410. Accordingly, the ground pattern 410 and the second dummy mesh pattern 420 spaced apart from each other by a separation region may be formed.

In some embodiments, the ground pattern 410 and the second dummy mesh pattern 420 may be substantially integral with each other. For example, the conductive layer may be formed on the top surface of the ground substrate 405. The entire conductive layer may be patterned into a mesh structure, and then segmented regions may be formed only in a region of the second dummy mesh pattern 420. Accordingly, the ground pattern 410 and the second dummy mesh pattern 420 may be formed without the formation of the additional separation region.

In some embodiments, the ground pattern 410 and the second dummy mesh pattern 420 may be directly formed on the bottom surface of the dielectric layer 100. For example, the conductive layer may be formed on the bottom surface of the dielectric layer 100, and then may be etched to form the ground pattern 410 and the second dummy mesh pattern 420.

In some embodiments, the ground pattern 410 may also share the mesh structure. Accordingly, transmittance of the ground pattern 410 may be improved. As the second dummy mesh pattern 420 is distributed, optical properties of the ground layer 400 may entirely become uniform. Thus, the ground layer 400 or the ground pattern 410 may be prevented from being visually recognized.

The second dummy mesh pattern 420 may include conductive lines intersecting each other to form the mesh structure therein. In some embodiments, the second dummy mesh pattern 420 may include the segmented regions where the conductive lines are cut. Accordingly, disturbance of radiation properties of the second antenna unit 300 by the second dummy mesh pattern 420 may be prevented and the omni-directional radiation may be implemented.

In some embodiments, the second dummy mesh pattern 420 may overlap the second antenna unit 300 in the plan view. For example, the second dummy mesh pattern 420 including the segmented regions may not serve as a conductive ground to the second antenna unit 300. Accordingly, deterioration of the broad-band/multi-band properties and the omni-directional radiation properties of the second antenna unit 300 may be prevented.

As described above, the first antenna unit 200 may provide the vertical radiation, and the second antenna unit 300 may provide the omni-directional radiation.

For example, the antenna device may be attached to the object as mentioned below. In this case, a high-frequency signal may be strongly transmitted and received at an inside of the object through the directed radiation from the first antenna unit 200. Additionally, connection of the antenna device to the external communication network of the target object may be stably performed through the omni-directional radiation of the second antenna unit 300.

The above-described antenna device may be applied to various structures and objects such as a window of public transportation such as a bus and a subway, a building, a vehicle, a decorative sculpture, a guidance sign (e.g., a direction sign, an emergency exit sign, an emergency light, etc.), and may serve as, e.g., a relay antenna structure. The relay antenna structure may include, e.g., an access point (AP) such as a repeater, a router, a small cell, an internet router, etc.

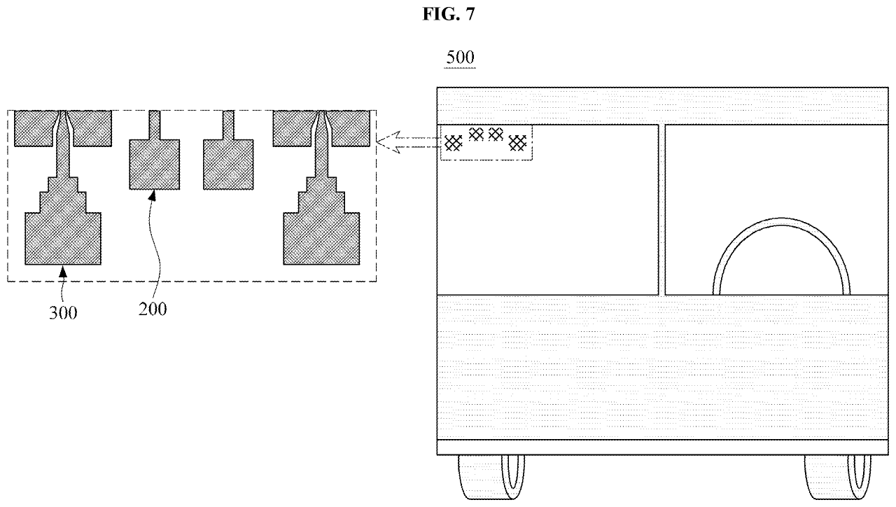

FIG. 7 is a schematic view illustrating an exemplary application of an antenna device in accordance with exemplary embodiments.

For example, FIG. 7 is a schematic view illustrating a router structure in which an antenna device is attached to an object 500 (e.g., public transportation such as a bus or a subway).

Referring to FIG. 7, the antenna device may have a structure that may be fixed to a window of public transportation, a wall or a ceiling of a building structure, a window, a vehicle, a sign, etc. For example, the above-described first and second antenna units 200 and 300 may be inserted into or attached to a substrate.

For example, the substrate may serve as the dielectric layer 100 as illustrated in FIG. 1. In an embodiment, the first and second antenna units 200 and 300 may be buried in the substrate. The substrate may serve as public transport windows, a building, various decorative structures, an instruction sign, a window, etc.

For example, a laminate of the ground layer 400-the dielectric layer 100-the antenna units 200 and 300 may be attached to the substrate or may be inserted into the substrate.

In some embodiments, the above-described antenna device may be attached to the substrate in the form of a film.

As described above, the first dummy mesh pattern 250 may be formed around the first and second antenna units 200 and 300 to reduce or prevent a visual recognition of the first and second antenna units 200 and 300. At least a portion of the first and second antenna units 200 and 300 may also have a mesh structure.

In some embodiments, the second dummy mesh pattern 420 may be formed around the ground pattern 410 of the ground layer 400 to reduce or prevent the ground layer 400 from being visually recognized. The ground pattern 410 may also include a mesh structure.

In some embodiments, the first antenna unit 200 and the second antenna unit 300 may be connected to an external circuit board through end portions of the first transmission line 220 and the second transmission line 320, respectively. For example, the external circuit board may be a PCB (Printed Circuit Board) including a rigid board.

For example, a conductive bonding structure such as an anisotropic conductive film (ACF) may be attached on the end portions of the first transmission line 220 and the second transmission line 320, and then a bonding area of the external circuit board may be disposed on the conductive bonding structure. Thereafter, the external circuit board may be connected to the first antenna unit 200 and the second antenna unit 300 through a heat treatment/pressing process.

An antenna cable may be electrically connected to the conductive bonding structure to supply a power to the first antenna unit 200 and the second antenna unit 300.

For example, the antenna cable may be buried in the object 500, and may be coupled with an external power supply, an integrated circuit chip or an integrated circuit board. Accordingly, the power may be supplied to the first antenna unit 200 and the second antenna unit 300, and antenna radiation may be performed.

As described above, the first antenna unit 200 may provide the vertical radiation toward the inside of the object 500 (e.g., public transportation such as a bus, a subway, a train, etc.) so that stable signal transmission and reception may be implemented within the object 500. The second antenna unit 300 may be stably connected to a communication network at an outside of the object 500 through the omni-directional radiation. Therefore, a stable connection with the external communication network and enhanced signal transmission and reception efficiency within the object 500 may be implemented from the single antenna device.

As illustrated in FIG. 7, the above-described antenna unit 200 and 300 may be attached to the object 200 (e.g., a window of public transportation such as a bus or subway) and may be electrically connected to a Wi-Fi repeater in public transportation through an antenna cable. Accordingly, a multi-band wireless communication network may be implemented within public transportation.

What is claimed is:

1. An antenna device comprising:
a dielectric layer having a central portion and a peripheral portion;
a first antenna unit disposed on a top surface of the dielectric layer, the first antenna unit comprising a first radiator providing a vertical radiation from the top surface of the dielectric layer; and
a second antenna unit spaced apart from the first antenna unit on a plan view, the second antenna unit comprising a second radiator configured to provide an omni-directional radiation.

2. The antenna device according to claim 1, wherein the first antenna unit further comprises a first transmission line electrically connected to the first radiator.

3. The antenna device according to claim 1, wherein the second radiator comprises a plurality of radiation portions, widths of which sequentially decrease.

4. The antenna device according to claim 3, wherein the plurality of radiation portions comprise a first radiation portion, a second radiation portion and a third radiation portion, widths of which sequentially decrease.

5. The antenna device according to claim 4, wherein the first radiation portion, the second radiation portion and the third radiation portion are arranged in a stepped shape.

6. The antenna device according to claim 1, wherein the second antenna unit further comprises:
a second transmission line electrically connected to the second radiator; and
an auxiliary radiator disposed around the second transmission line and physically spaced apart from the second radiator and the second transmission line.

7. The antenna device according to claim 6, wherein the auxiliary radiator serves as a fourth radiation portion.

8. The antenna device according to claim 1, wherein the first radiator and the second radiator have a mesh structure.

9. The antenna device according to claim 8, further comprising a first dummy mesh pattern disposed around the first antenna unit and the second antenna unit to be spaced apart from the first antenna unit and the second antenna unit.

10. The antenna device according to claim 1, wherein an area of the first radiator is smaller than an area of the second radiator.

11. The antenna device according to claim 1, wherein the first antenna unit comprises a plurality of first antenna units, and the second antenna unit comprises a plurality of second antenna units.

12. The antenna device according to claim 11, wherein the plurality of first antenna units are disposed on the central portion of the dielectric layer, and the plurality of second antenna units are disposed on the peripheral portion of the dielectric layer.

13. The antenna device according to claim 11, wherein a distance between centers of the first radiators included in neighboring first antenna units among the plurality of first antenna units is ¼ of a radiation wavelength of the first radiator, and
a distance between centers of the second radiators included in neighboring second antenna units among the plurality of second antenna units is ¼ of a radiation wavelength of the second radiator.

14. The antenna device according to claim 1, further comprising a ground layer disposed on a bottom surface of the dielectric layer, the ground layer comprising a ground pattern.

15. The antenna device according to claim 14, wherein at least a portion of the ground pattern overlaps the first antenna unit in the plan view.

16. The antenna device according to claim 14, wherein the ground pattern is spaced apart from the second antenna unit in the plan view.

17. The antenna device according to claim 14, wherein the ground pattern has a mesh structure.

18. The antenna device according to claim 17, wherein the ground layer further comprises a second dummy mesh pattern disposed around the ground pattern.

19. The antenna device according to claim 18, wherein at least a portion of the second dummy mesh pattern overlaps the second antenna unit in the plan view.

20. The antenna device according to claim 18, wherein the second dummy mesh pattern comprises conductive lines crossing each other, and the second dummy mesh pattern has segmented regions at which the conductive lines are cut.
